(19) United States
(12) Patent Application Publication
(10) Pub. No.: US 2011/0243397 A1
(43) Pub. Date: Oct. 6, 2011

(54) SEARCHING DIGITAL IMAGE COLLECTIONS USING FACE RECOGNITION

(76) Inventors: Christopher Watkins, Penfield, NY (US); Timothy J. White, Webster, NY (US); Yasunobu Kikuchi, Tokyo (JP)

(21) Appl. No.: 12/749,538

(22) Filed: Mar. 30, 2010

(51) Int. Cl. G06K 9/00; G06F 3/041; H04N 5/222; G06F 3/048; G06F 3/033

(52) U.S. Cl. 382/118; 345/173; 348/333.05; 715/838; 715/830; 715/863; 348/E05.024

(57) ABSTRACT

A method for searching a collection of digital images on a display screen, comprising: entering an image review mode and displaying on the display screen a first digital image from the collection of digital images; designating a face contained in the first digital image by using an interactive user interface to indicate a region of the displayed first digital image containing the face; using a processor to execute an automatic face recognition algorithm to identify one or more additional digital images from the collection of digital images that contain the designated face; and displaying the identified one or more additional digital images on the display screen.

### FIELD OF THE INVENTION

This invention pertains to the field of searching collections of digital images, and more particularly to methods for searching collections of digital images using automatic facial recognition.

### BACKGROUND OF THE INVENTION

Digital cameras have become very common and have largely replaced traditional film cameras. Today, most digital cameras incorporate a display screen on the back of the camera to enable image preview and provide user interface elements for adjusting camera settings. The display screen can also be used to browse through images that have been captured using the digital camera and are stored in the digital camera's memory. To use this capability, the user typically puts the camera into a review mode and uses buttons or other user controls to scroll through the images one at a time. When a large number of digital images are stored in the digital camera, it can be a time-consuming and frustrating process to scroll through the images to find the ones of interest.

U.S. Pat. No. 6,813,395 to Kinjo, entitled “Image Searching Method and Image Processing Method,” teaches an image searching method that recognizes specific information for an image and appends the information to the image data. The appended information can then be used to define searching conditions.

One attribute of a digital image that it is often desirable to be able to use in the process of searching and organizing image collections is the identity of persons contained in the images. Past solutions have involved manually tagging images with metadata identifying the people in the image. However, this can be a time-consuming and frustrating process for a user.

Squilla, et al., in U.S. Pat. No. 6,810,149, teach an improved method wherein image icons showing, for example, the face of various individuals known to the user are created by the user, and subsequently used to tag images in a user's digital image collection. This visually oriented association method improves the efficiency of the identification process.

More recent digital imaging products have added face detection algorithms which automatically detect faces in each digital image of a digital image collection. The detected faces are presented to the user so that the user can input the identity of the detected face. For example, the user can input the identity of a detected face by typing the individual's name or by clicking on a predefined image icon associated with the individual.

Even more advanced digital imaging products have added facial recognition algorithms to assist in identifying individuals appearing in a collection of digital images. Current facial recognition algorithms typically assign a probability of a match of a target image to images which are been previously identified based on one or more features of a target face, such as eye spacing, mouth distance, nose distance, cheek bone dimensions, hair color, skin tone, and so on.

Examples of facial recognition techniques can be found in U.S. Pat. No. 4,975,969 to Tal, entitled “Method and apparatus for uniquely identifying individuals by particular physical characteristics and security system utilizing the same,” and U.S. Pat. No. 7,599,527 to Shah et al., entitled “Digital image search system and method.”

U.S. Patent Application Publication 2009/0252383 to Adam et al., entitled “Method and Apparatus to Incorporate Automatic Face Recognition in Digital Image Collections,” discloses a method for updating a facial image database from a collection of digital images. Facial recognition templates are used to recognize faces in collections of digital images. The recognized faces can be used for purposes such as forming customized slide shows.

In the article “Efficient Propagation for face annotation in family albums” (Proceedings of the 12th ACM International Conference on Multimedia. pp. 716-723, 2004), Zhang et al. teach a method for annotating photographs where a user selects groups of photographs and assigns names to the photographs. The system then propagates the names from a photograph level to a face level by inferring a correspondence between the names and faces. This work is related to that described in U.S. Pat. No. 7,274,872.

U.S. Patent Application Publication 2007/0172155 to Guckenberger, entitled “Photo Automatic Linking System and Method for Accessing, Linking and Visualize ‘Key-Face’ and/or Multiple Similar Facial Images Along with Associated Electronic Data via a Facial Image Recognition Search Engine,” discloses a method to search facial image databases to find people that have an appearance similar to the face in an input digital image. The disclosed method is used to identify celebrity look-a-likes.

U.S. Pat. No. 7,345,675 to Minakuchi et al., entitled “Apparatus for Manipulating an Object Displayed on a Display Device by Using a Touch Screen,” teaches a method for manipulating objects displayed on a display device having a touch screen.

U.S. Pat. No. 7,479,949 to Jobs et al., entitled “Touch Screen Device, Method, and Graphical User Interface for Determining Commands by Applying Heuristics,” teaches a method for interacting with a computing device comprising detecting one or more touch positions on a touch screen.

U.S. Patent Application Publication 2008/0163119 to Kim, entitled “Method for Providing Menu and Multimedia Device Using the Same” discloses a multimedia device including a touch screen which can be used to enable a user to interact with menu icons for the purpose of controlling the operation of the device.

U.S. Patent Application Publication 2008/0165141 to Christie, entitled “Gestures for Controlling, Manipulating and Editing of Media Files using Touch Sensitive Devices,” discloses a method for using a touch sensitive display to manage and edit media files on a computing device.

U.S. Patent Application Publication 2008/0297484 to Park, entitled “Method and Apparatus for Providing Gesture Information Based on Touchscreen and Information Terminal Device Having the Apparatus,” discloses a method for enabling user interface interaction based on a touch screen. The method includes displaying guide information if a touch of the touch screen is sensed.

There remains a need for an efficient and user-friendly method for browsing collections of digital images on digital imaging devices that enables a user to find images containing a particular person. In particular, there is a need for a method that is well-suited for use on a digital imaging device having a touch screen user interface.

### SUMMARY OF THE INVENTION

The present invention represents method for searching a collection of digital images on a display screen, comprising:

entering an image review mode and displaying on the display screen a first digital image from the collection of digital images;

designating a face contained in the first digital image by using an interactive user interface to indicate a region of the displayed first digital image containing the face;

using a processor to execute an automatic face recognition algorithm to identify one or more additional digital images from the collection of digital images that contain the designated face; and

displaying the identified one or more additional digital images on the display screen.

This invention has the advantage that it facilitates efficient searching of large sets of images to automatically locate images in the set that include a designated individual, based on facial recognition data.

This invention has the additional advantage that it facilitates organization of images from a large set of digital images into collections of digital images containing individual people based on facial recognition data, as well as sharing of these collections of digital image with others.

It has the further advantage that additional user-specified search criteria can be designated to further refine the set if identified images containing the designated individual.

### BRIEF DESCRIPTION OF THE DRAWINGS

FIG. 1 is a high-level diagram showing the components of a digital camera system for implementing the present invention;

FIG. 2 is a flow diagram outlining a method for searching a collection of digital images according to a preferred embodiment of the present invention;

FIG. 3A is a diagram illustrating one embodiment of a digital camera according to the present invention;

FIG. 3B illustrates designating a face contained in a digital image displayed on the digital camera of FIG. 3A according to the method of the present invention;

FIG. 4 is a flow diagram showing additional details of the identify additional digital images containing face step of FIG. 2 according to one embodiment of the present invention.

FIG. 5 illustrates the display of menu options provided if the face designated in FIG. 3B has not been previously identified;

FIG. 6A illustrates displaying a set of digital images that contain the face designated in FIG. 3B as a set of thumbnail images;

FIG. 6B illustrates displaying a set of digital images that contain the face designated in FIG. 3B in a collage format;

FIG. 6C illustrates displaying a set of digital images that contain the face designated in FIG. 3B in a filmstrip format;

FIG. 6D illustrates displaying a set of digital images that contain the face designated in FIG. 3B in an alternate thumbnail image format; and

FIG. 7 illustrates the display of menu options provided for defining additional search criteria.

It is to be understood that the attached drawings are for purposes of illustrating the concepts of the invention and may not be to scale.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, a computer program for performing the method of the present invention can be stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

Because digital cameras employing imaging devices and related circuitry for signal capture and correction and for exposure control are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

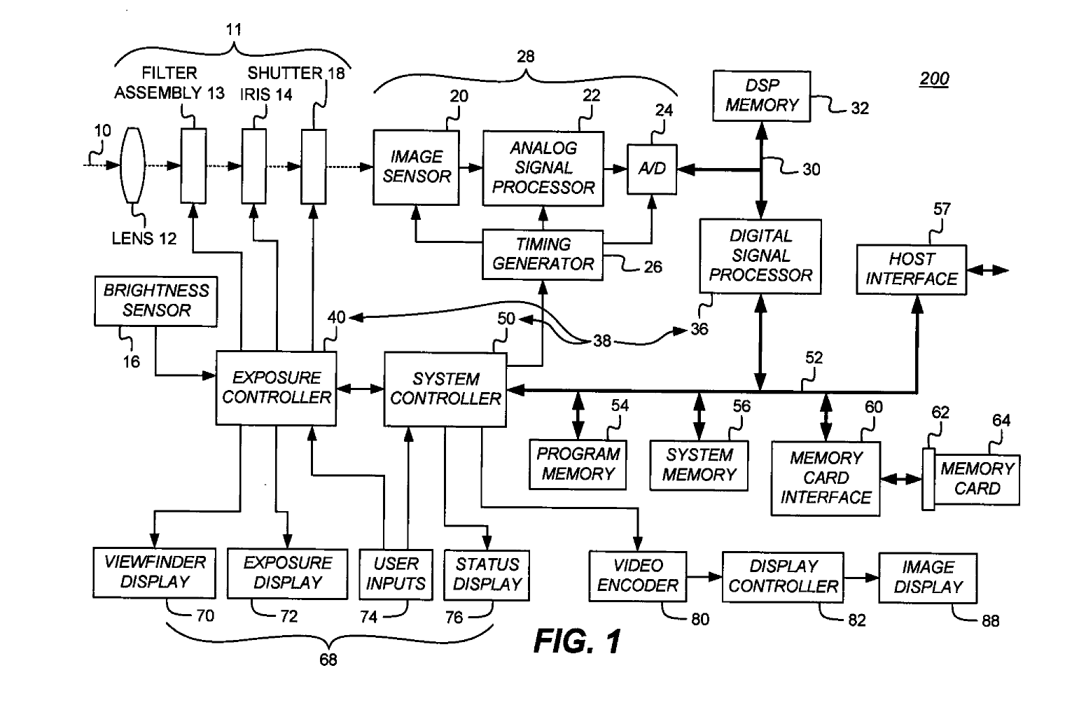

Turning now to FIG. 1, a block diagram of a digital imaging device embodying the present invention is shown. In this example, the digital imaging device is shown as a digital camera 200. However, although a digital camera configuration will now be explained, the present invention is clearly applicable to other types of digital imaging devices as well, including digital picture frames digital imaging kiosks, handheld consumer electronic devices and cell phones. The present invention is also applicable to personal computers executing digital imaging applications, either locally or over the internet.

In the digital camera 200, light from the subject scene 10 is input to an imaging stage 11, where the light is focused by lens 12 to form an image on a solid state color filter array image sensor 20. Color filter array image sensor 20 converts the incident light to an electrical signal for each picture element (pixel). The color filter array image sensor 20 of the preferred embodiment is a charge coupled device (CCD) type or an active pixel sensor (APS) type. (APS devices are often referred to as CMOS sensors because of the ability to fabricate them in a Complementary Metal Oxide Semiconductor process.) Other types of image sensors having two-dimensional array of pixels can also be used provided that they employ the patterns of the present invention. The color filter array image sensor 20 for use in the present invention comprises a two-dimensional array of color and panchromatic pixels as will become clear later in this specification after FIG. 1 is described.

The amount of light reaching the color filter array image sensor 20 is regulated by an iris block 14 that varies the aperture and a neutral density (ND) filter block 13 that includes one or more ND filters interposed in the optical path. Also regulating the overall light level is the time that a shutter 18 is open. An exposure controller 40 responds to the amount of light available in the scene as metered by a brightness sensor block 16 and controls all three of these regulating functions.

This description of a particular camera configuration will be familiar to one skilled in the art, and it will be obvious that many variations and additional features are present. For example, an autofocus system can be added, or the lens can be detachable and interchangeable. It will be understood that the present invention can be applied to any type of digital camera, where similar functionality is provided by alternative components. For example, the digital camera 200 can be a relatively simple point-and-shoot digital camera, where the shutter 18 is a relatively simple movable blade shutter, or the like, instead of the more complicated focal plane arrangement. The present invention can also be practiced using imaging components included in non-camera devices such as mobile phones and automotive vehicles.

The analog signal from the color filter array image sensor 20 is processed by analog signal processor 22 and applied to analog-to-digital (AID) converter 24. A timing generator 26 produces various clocking signals to select rows and pixels and synchronizes the operation of analog signal processor 22 and A/D converter 24. An image sensor stage 28 includes the color filter array image sensor 20, the analog signal processor 22, the A/D converter 24, and the timing generator 26. The components of image sensor stage 28 can be separately fabricated integrated circuits, or they can be fabricated as a single integrated circuit as is commonly done with CMOS image sensors. The resulting stream of digital pixel values from the A/D converter 24 is stored in a digital signal processor (DSP) memory 32 associated with a digital signal processor (DSP) 36.

The DSP 36 is one of three processors or controllers in this embodiment, in addition to a system controller 50 and an exposure controller 40. Although this partitioning of camera functional control among multiple controllers and processors is typical, these controllers or processors can be combined in various ways without affecting the functional operation of the camera and the application of the present invention. These controllers or processors can include one or more digital signal processor devices, microcontrollers, programmable logic devices, or other digital logic circuits. Although a combination of such controllers or processors has been described, it should be apparent that one controller or processor can be designated to perform all of the needed functions. All of these variations can perform the same function and fall within the scope of this invention, and the term “processing stage” will be used as needed to encompass all of this functionality within one phrase, for example, as in processing stage 38 in FIG. 1.

In the illustrated embodiment, DSP 36 manipulates the digital image data in the DSP memory 32 according to a software program permanently stored in a program memory 54 and copied to DSP memory 32 for execution during image capture. DSP 36 executes the software necessary for practicing image processing shown in FIG. 1. DSP memory 32 can be any type of random access memory, such as SDRAM. The bus 30 including a pathway for address and data signals connects DSP 36 to its related DSP memory 32, A/D converter 24 and other related devices.

System controller 50 controls the overall operation of the camera based on a software program stored in program memory 54, which can include Flash EEPROM or other nonvolatile memory. This memory can also be used to store image sensor calibration data, user setting selections and other data which must be preserved when the camera is turned off. System controller 50 controls the sequence of image capture by directing exposure controller 40 to operate the lens 12, ND filter block 13, iris block 14, and shutter 18 as previously described, directing the timing generator 26 to operate the color filter array image sensor 20 and associated elements, and directing DSP 36 to process the captured image data. After an image is captured and processed, the final image file stored in DSP memory 32 is transferred to a host computer via host interface 57, stored on a removable memory card 64 or other storage device, and displayed for the user on an image display 88.

A system controller bus 52 includes a pathway for address, data and control signals, and connects system controller 50 to DSP 36, program memory 54, a system memory 56, host interface 57, a memory card interface 60 and other related devices. Host interface 57 provides a high speed connection to a personal computer (PC) or other host computer for transfer of image data for display, storage, manipulation or printing. This interface can be an IEEE1394 or USB2.0 serial interface or any other suitable digital interface. Memory card 64 is typically a Compact Flash (CF) card inserted into memory card socket 62 and connected to the system controller 50 via memory card interface 60. Other types of storage that can be utilized include without limitation PC-Cards, MultiMedia Cards (MMC), or Secure Digital (SD) cards.

Processed images are copied to a display buffer in system memory 56 and continuously read out via video encoder 80 to produce a video signal. This signal is output directly from the camera for display on an external monitor, or processed by display controller 82 and presented on image display 88. This display is typically an active matrix color liquid crystal display (LCD), although other types of displays are used as well.

A user interface 68, including all or any combination of a viewfinder display 70, an exposure display 72, a status display 76, the image display 88, and user inputs 74, is controlled by a combination of software programs executed on exposure controller 40 and system controller 50. User inputs 74 typically include some combination of buttons, rocker switches, joysticks, rotary dials. According to the present invention, the user inputs 74 include at least a display screen with a touch screen user interface. Exposure controller 40 operates light metering, exposure mode, autofocus and other exposure functions. The system controller 50 manages a graphical user interface (GUI) presented on one or more of the displays, e.g., on image display 88. The GUI typically includes menus for making various option selections and review modes for examining captured images.

Exposure controller 40 accepts user inputs selecting exposure mode, lens aperture, exposure time (shutter speed), and exposure index or ISO speed rating and directs the lens 12 and shutter 18 accordingly for subsequent captures. The brightness sensor block 16 is employed to measure the brightness of the scene and provide an exposure meter function for the user to refer to when manually setting the ISO speed rating, aperture and shutter speed. In this case, as the user changes one or more settings, the light meter indicator presented on viewfinder display 70 tells the user to what degree the image will be over or underexposed. In an automatic exposure mode, the user changes one setting and the exposure controller 40 automatically alters another setting to maintain correct exposure, e.g., for a given ISO speed rating when the user reduces the lens aperture, the exposure controller 40 automatically increases the exposure time to maintain the same overall exposure.

The foregoing description of the digital camera 200 will be familiar to one skilled in the art. It will be obvious that there are many variations of this embodiment that are possible and are selected to reduce the cost, add features or improve the performance of the camera. The following description will disclose in detail a method for searching a collection of digital images captured and stored on a camera according to the present invention. Although this description is with reference to digital camera 200, it will be understood that the present invention applies to any type of system for searching a collection of images. For example, the present invention can be used for digital picture frame systems, digital imaging kiosks, handheld consumer electronic devices, cell phones or digital imaging applications running on a personal computer.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

The phrase “digital image” or “digital image file”, as used herein, refers to any digital image file, such as a digital still image or a digital video file.

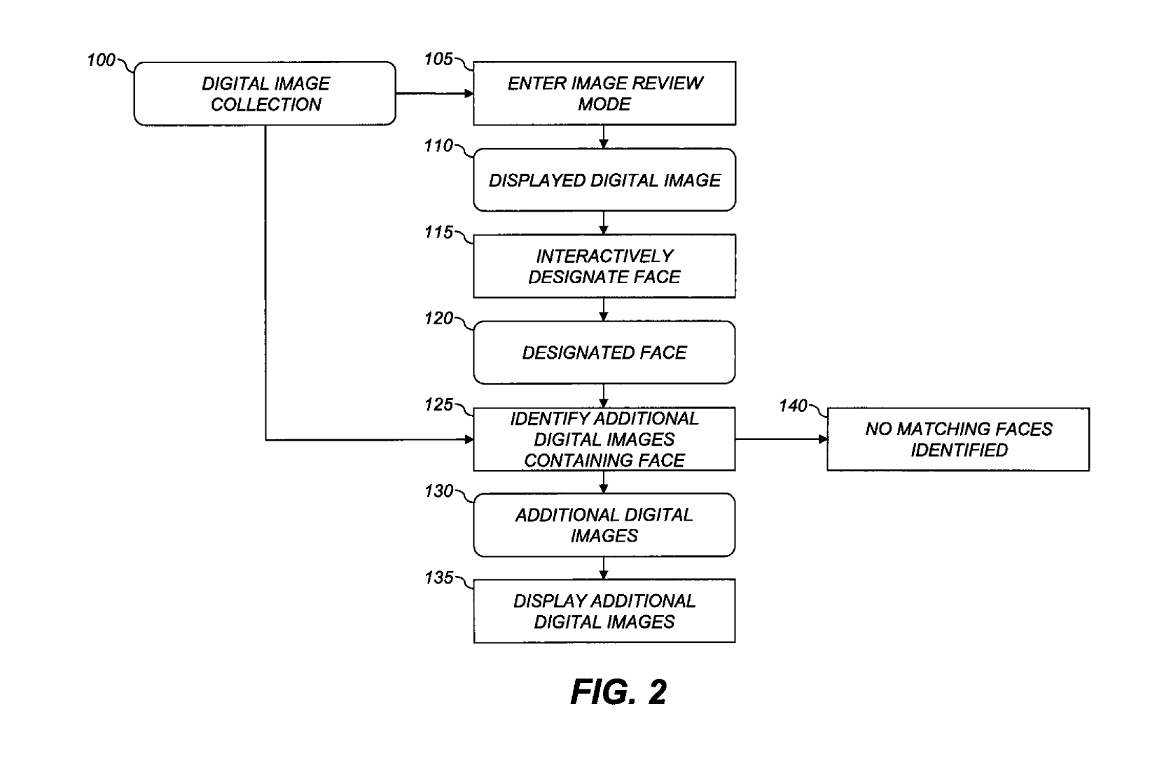

The present invention will now be described with reference to FIG. 2, which illustrates a flow diagram outlining a method for searching a digital image collection 100 on a device having a display screen according to a preferred embodiment of the present invention.

A user initiates an enter image review mode step 105 for the purpose of reviewing digital images in the digital image collection 100. For example, a user can initiate the enter image review mode step 105 by pushing an appropriate user interface button or by selecting an option from a user interface menu. When the enter image review mode step 105 is initiated, a first digital image from the digital image collection 100 is displayed on the display screen. In the image review mode, the user can browse through the digital image collection 100 to review individual digital images, which are displayed on the display screen as displayed digital image 110.

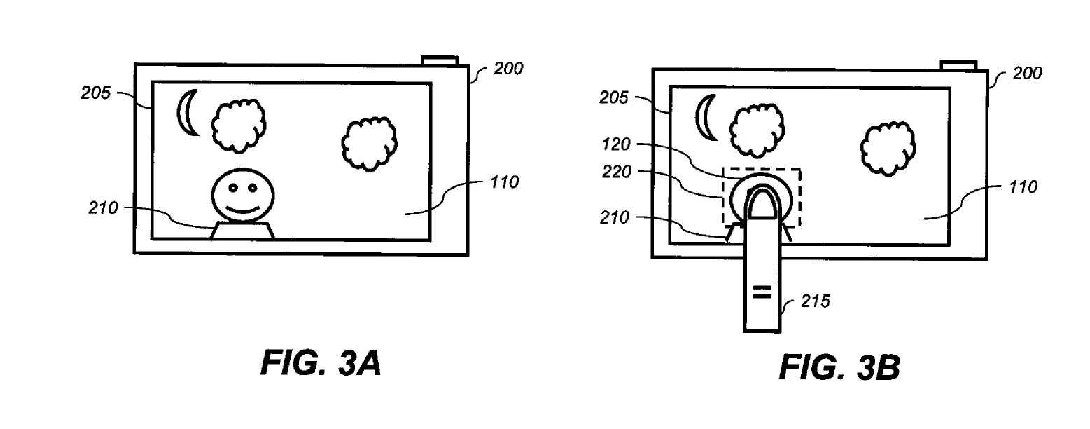

For illustration purposes, FIG. 3A shows a digital camera 200 having a touch screen 205. The digital camera 200 is used to capture digital images, which are typically stored some sort of memory such as an SD card or a RAM, constituting the digital image collection 100. In FIG. 3A, the enter image review mode step 105 has been initiated, and the displayed digital image 110 is displayed on the touch screen 205. The displayed digital image 110 in this example includes a person 210.

Returning to a discussion of FIG. 2, an interactively designate face step 115 is performed by a user to designate a face in the displayed digital image 110. One skilled in the art will recognize that there are many ways that could be used to interactively designate a face in the displayed digital image 110 to identify a designated face 120. In one embodiment, the displayed digital image 110 is displayed on a display screen with a touch sensitive surface, and the user designates a face by tapping on the face with a predefined number of taps (e.g., double tap or single tap). FIG. 3B shows an example of a finger 215 tapping on the face of person 210 in the displayed digital image 110 on the touch screen 205 of the digital camera 200. In this example, when the user taps on the face an outline 220 is briefly shown around the designated face 120 for a specified time interval to provide visual feedback to the user.

In alternate embodiments using a touch screen 205, the user can designate a face using some other type predefined user gesture rather than tapping on the face. For example, the user can select the designated face 120 by tracing a circle around a face in the displayed digital image 110 with his/her finger, or by tracing a diagonal line across the face to define a rectangular region containing the face. One skilled in the art will recognize that many other types of user gestures could also be used to select the designated face 120 in the displayed digital image 110.

In other embodiments a display screen without a touch screen user interface is used to display the displayed digital image 110. In this case, the designated face 120 can be interactively selected using any means known to those skilled in the art. For example, the user can use an interactive pointing device such as a mouse, a joystick, a track-ball, a track-pad, a remote control or a graphics tablet to select the designated face. The pointing device can be used to select the designated face by actions such as clicking on the face, dragging across the face to define a rectangular bounding box around the face, or tracing a circle around the face.

Returning to a discussion of FIG. 2, once the user has interactively selected a designated face 120, an identify additional digital images containing face step 125 is used to compare the designated face 120 to other images in the digital image collection 100 by applying a face recognition algorithm to identify any additional digital images 130 that contain the designated face 120.

There are a variety of techniques known in the art for performing facial recognition comparisons. For example, U.S. Pat. No. 4,975,969, incorporated herein by reference, teaches a technique whereby facial parameter ratios, such as the ratio between the distance between eye retina centers and the distance between the right eye and the mouth center, are measured and compared between two images. Another useful ratio includes the ratio between the distance between the eye retina centers and the distance between the left eye retina and the nose bottom. When using a facial feature ratio comparison technique, it is preferred that a plurality of such ratios is measured.

The distances and ratios associated with a face can be considered to be a representation of identifying characteristics of a face. Various other methods to represent identifying characteristics of a face will be known to those skilled in the art. Any such method can be used in accordance with the present invention. The data used to characterize a face can be referred to as a “faceprint” or a “face template.”

Faceprints for the faces in the digital images in the digital image collection can be calculated in real time when the identify additional digital images containing face step 125 is being executed by loading the relevant digital images into memory. Alternately, the faceprints can be pre-calculated and stored in a database for later use. For example, the faceprints can be calculated and stored in a faceprint database at the time that the digital images are captured, or whenever a face recognition operation is initiated by the user.

Once a digital image has been identified to contain a particular face, the digital image can be tagged appropriately so that the face recognition computations, which can be time-consuming, do not need to be executed repeatedly. The identified faces can be tagged by adding metadata to the digital image file indicating the location, size and identity of the face in the digital image. The metadata can then be examined to determine whether a digital image contains a particular face. Alternatively, information about the location, size and identity of the faces in the digital images of the digital image collection can be stored in an identified faces database.

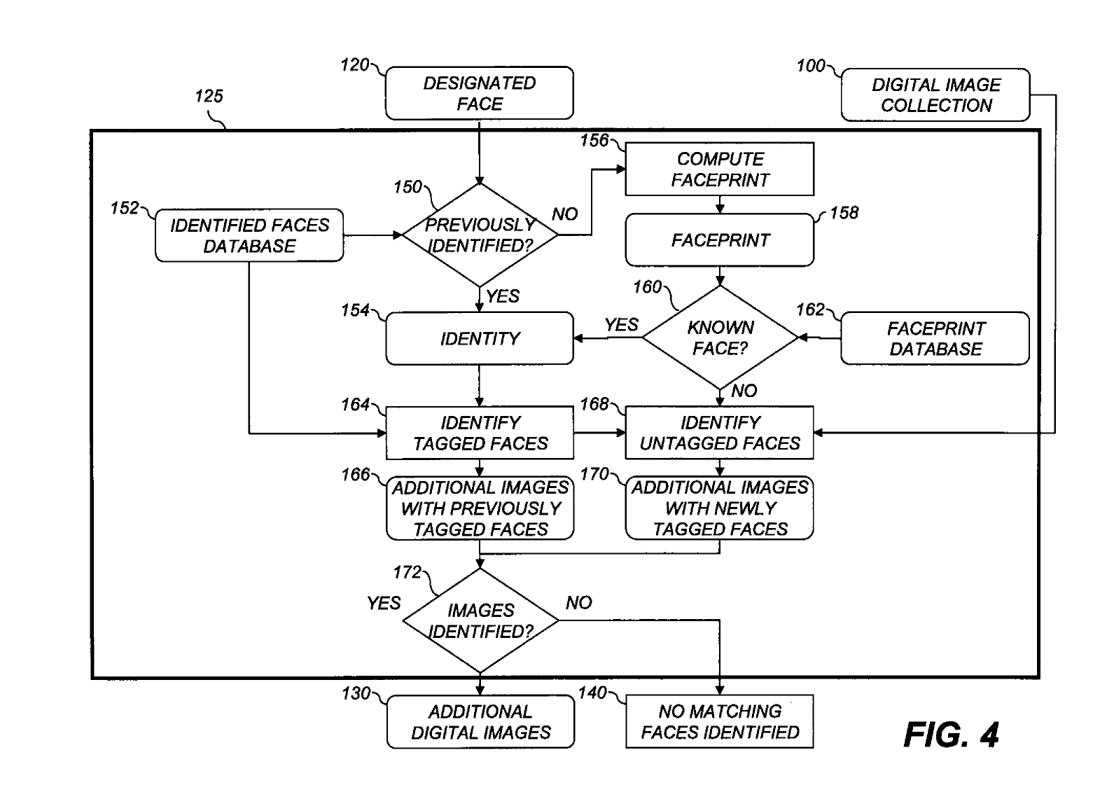

FIG. 4 shows a flowchart of a method for implementing the identify additional digital images containing face step 125 according to one embodiment of the present invention. In this embodiment, an identified faces database 152 is a database storing a list of the identity and location of faces that have been previously identified for digital images in the digital image collection 100. A faceprint database 162 is a database storing faceprints for previously identified faces. If multiple images containing a particular face are identified, the average or median values for the faceprint parameters can be stored in the faceprint database 162 to increase the reliability of faceprint identification.

A previously identified test 150 is applied to compare the designated face 120 to the identified faces database 152 to determine whether the designated face 120 has been previously identified. If it has been previously identified, an identity 154 is provided. The identity could for example be a text string indicating a name, although it could also be some other form of identifier that uniquely identifies a person such as an ID number.

If the designated face 120 has not been previously identified, a compute faceprint step 156 is used to determine a faceprint 158 characterizing the designated face 120. The faceprint 158 could be a set of distances and ratios associated with a face as described above, or it can be some other representation of facial characteristics, such as various statistical parameters, or even a bitmap of the face. A known face test 160 is used to compare the faceprint 158 to the faceprint database 162 to determine whether the designated face 120 corresponds to any previously identified face. The faceprint 158 can be compared to the faceprints in the faceprint database 162 using any method known to those skilled in the art. For example, if the faceprint 158 is a set of distances and ratios associated with a face, then the distances and ratios for the faceprint 158 can be compared to those in the faceprint database 162. If a close enough match is found, then the corresponding identity 154 is assigned to designated face 120.

If identity 154 was determined (using either the previously identified test 150 or the known face test 160) an identify tagged faces step 164 is used to identify a list of additional images with previously tagged faces 166. This step is performed by searching the identified faces database 152 to identify any digital images that had been previously tagged to indicate that they contain a face matching the determined identity 154.

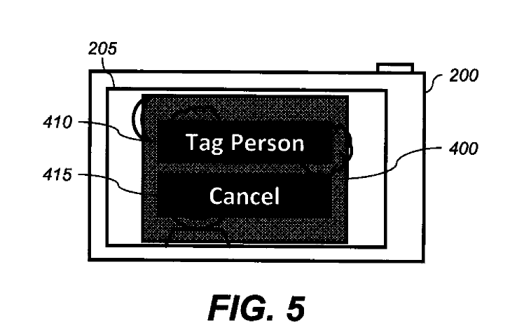

If the known face test 160 determines that the faceprint 158 doesn't match any of the faceprints in the faceprint database 162, then the user is given the opportunity to provide an identity to be associated with the faceprint 158, and the faceprint database 162 is updated accordingly. FIG. 5 shows an example of a user interface that can be presented to the user if the designated face 120 that was selected by the user in FIG. 3B is not present in the faceprint database 162 (FIG. 4). An option menu 400 includes a tag person option 410 and a cancel option 415. If the user selects the tag person option 410, the user is prompted to enter a name for the designated face 120. If the user selects the cancel option 415, the face detection process is terminated.

Returning to a discussion of FIG. 4, an identify untagged faces step 168 is then executed to search the digital image collection 100 to find any faces matching the faceprint 158. Any such images are included in a list of additional images with newly tagged faces 170. If any such images are identified, the identified faces database 152 is updated accordingly to include this information. The identify untagged images step 168 can optionally be executed even if the faceprint 158 was determined to correspond to a known identity 154, particularly if there are any digital images in the digital image collection 100 that had previously not been evaluated using face detection.

An images identified test 172 is used to determine whether any additional images were included in either the additional images with previously tagged faces 166 or the additional images with newly tagged faces 170. If so, they are combined to form the list of additional digital images 130. If not, then a no matching faces identified step 140 is executed which alerts the user that no matching images were found.

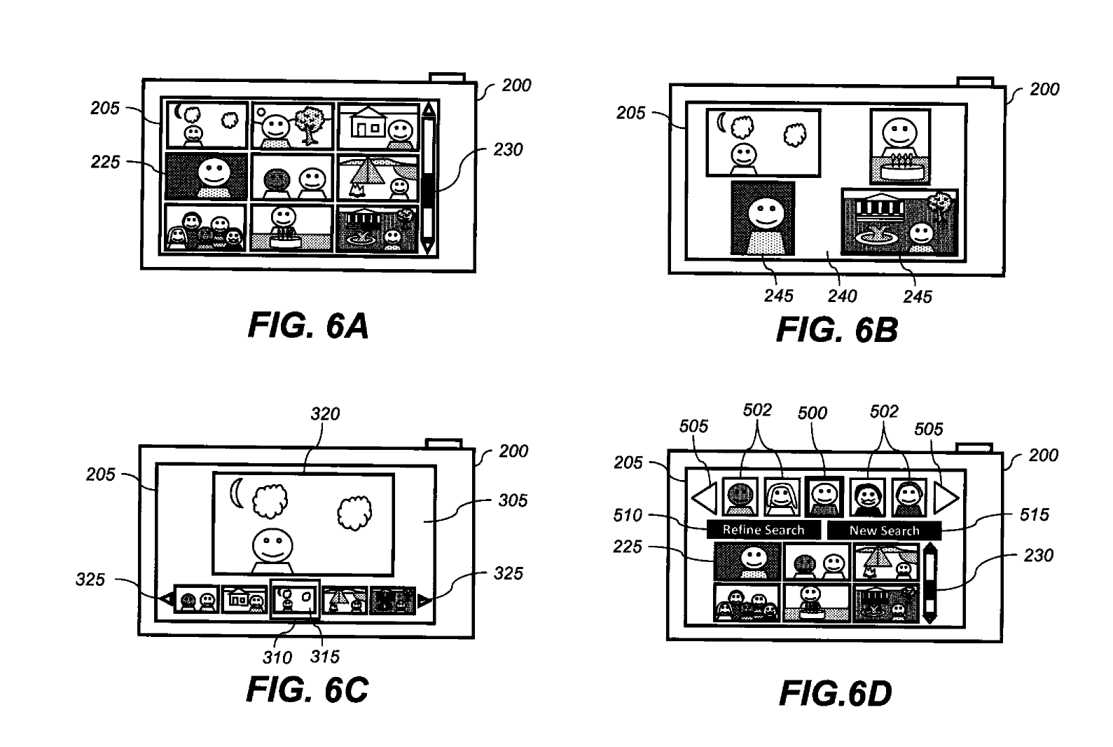

Returning to a discussion of FIG. 2, once the set of additional digital images 130 has been determined, a display additional digital images step 135 is executed to display the additional digital images 130 on the display screen. The additional digital images 130 can be displayed using any method known to those skilled in the art. FIGS. 6A-D show examples of several methods that the display additional digital images step 135 can use to display the additional digital images 130 on the touch screen 205 of the digital camera 200 from FIG. 3A.

FIG. 6A shows the additional digital images 130 (FIG. 2) displayed as an array of thumbnail images 225. If the number of additional digital images 130 is too large to fit on the touch screen 205 all at once, user interface elements, such as a scrollbar 230, can be provided to scroll through the additional digital images 130, displaying a subset of the additional digital images 130 that will fit on the touch screen 205.

FIG. 6B shows the additional digital images 130 (FIG. 2) displayed in a collage arrangement 240. The collage arrangement 240 includes a number of individual images 245 formatted in a particular pattern. In one embodiment of the present invention, if the number of additional digital images 130 is too large to fit in a single collage arrangement 240, a “slide show” is displayed where the entire set of additional digital images 130 is shown in a sequence of collage arrangements 240. The sequence of collage arrangements 240 can be advanced at a user selectable time interval, using a user selectable transition style. In some embodiments, the collage arrangement 240 can include only a single image, and the set of additional digital images 130 is sequentially displayed one at a time as a slide show.

FIG. 6C shows the additional digital images 130 (FIG. 2) displayed using a film strip arrangement 305. The film strip arrangement 305 includes directional user interface controls 325 that can be used to scroll through the additional digital images 130. A preview window icon 310 indicates the currently selected digital image of interest. A previewed digital image 315 is shown within the preview window icon 310, which is also shown in magnified form as magnified digital image 320. As a user interacts with the directional user interface indicators 325, the “film strip” containing the previewed digital image 315 is scrolled through the additional digital images 130 and the magnified digital image 320 is updated accordingly.

FIG. 6D shows a variation of the thumbnail image display of FIG. 6A that includes additional features. As in FIG. 6A, the user interface of FIG. 6D includes a set of thumbnail images 225 and a scrollbar 230. Additionally, a series of face images are displayed along the top of the touch screen 205 showing the current face 500 (highlighted in the center), as well as other previously identified faces 502. Directional user interface controls 505 are provided to scroll through the other previously identified faces 502 if there are more than can be fit onto the screen. If the user selects one of the other previously identified faces 502 (e.g., by tapping on it), the thumbnail images 225 are updated to show images containing the selected face and the current face 500 is updated accordingly to be the selected face.

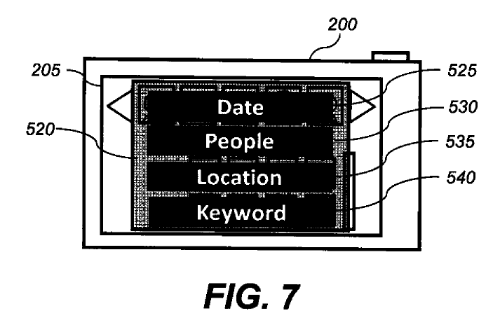

The configuration of FIG. 6D also includes a refine search option 510 that can be used to refine the set of additional digital images 130 according to additional user-defined search criteria. If the user selects the refine search option 510 (e.g., by tapping on it), then a menu is presented to the user, such as criteria menu 520 illustrated in FIG. 7. The criteria menu 520 includes a date option 525, a people option 530, a location option 535 and a keyword option 540.

If the user selects the date option 525 (e.g., but tapping on it), the user is prompted to specify a date/time range. The specified date/time range is then used to refine the set of additional digital images 130 by identifying a subset of the additional digital images 130 that were captured within the specified date/time range.

If the user selects the people option 530, the user is shown a list of previously identified faces and is allowed to select one (or more) of the faces. The set of additional digital images 130 is then refined by identifying a subset of the additional digital images 130 that contain both the current face 500 as well as the selected face(s).

Similarly, if the user selects the location option 535 or the keyword option 540, the set of additional digital images 130 is refined by identifying a subset of the additional digital images 130 that were captured at a user-specified geographic location, or have been tagged with a user-specified keyword, respectively. The geographic location at which an image was captured can be determined in a variety of ways. For example, some digital image capture devices include a global positioning system (GPS) sensor that can be used to automatically determine the geographic location. Alternatively, the geographic location can be manually specified by a user.

In some embodiments, the criteria menu 520 can also include other criteria options. For example, an event option can be provided to allow the user to specify images corresponding to a particular event type (e.g., birthday, Christmas or party). Those skilled in the art will recognize that event types for a collection of images can be automatically identified using semantic analysis algorithms, or alternately, they can be manually specified by a user.

The embodiment just described allows the user to combine multiple criteria by identifying subsets of the additional digital images 130 that simultaneously specify all of the criteria. Mathematically, this is equivalent to combining the criteria using a logical “AND” operation. In some embodiments, the user may be provided with options to combine search criteria in other manners. For example, the user can specify that the criteria can be combined using a logical “OR” operation, or using various combinations of “AND” and “OR” operations.

The configuration of FIG. 6D also includes a new search option 515. If the user selects the new search option 515, then the same criteria menu 520 of FIG. 7 is displayed. However, in this case, rather than refining the original search, the user can initiate a new search using one of the available search criteria.

The invention has been described in detail with particular reference to certain preferred embodiments thereof, but it will be understood that variations and modifications can be effected within the spirit and scope of the invention.

### PARTS LIST

10 light from subject scene
11 imaging stage
12 lens
13 neutral density (ND) filter block
14 iris block
16 brightness sensor block
18 shutter
20 color filter array image sensor
22 analog signal processor
24 analog-to-digital (A/D) converter
26 timing generator
28 image sensor stage
30 bus
32 digital signal processor (DSP) memory
36 digital signal processor (DSP)
38 processing stage
40 exposure controller
50 system controller
52 system controller bus
54 program memory
56 system memory
57 host interface
60 memory card interface
62 memory card socket
64 memory card
68 user interface
70 viewfinder display
72 exposure display
74 user inputs
76 status display
80 video encoder
82 display controller
88 image display
100 digital image collection
105 enter image review mode step
110 displayed digital image
115 designate face step
120 designated face
125 identify additional digital images containing face step
130 additional digital images
135 display additional digital images step
140 no matching faces identified step
150 previously identified test
152 identified faces database
154 identity
156 compute faceprint step
158 faceprint
160 known face test
162 faceprint database
164 identify tagged faces step
166 additional images with previously tagged faces
168 identify untagged faces step
170 additional images with newly tagged faces
172 images identified test
200 digital camera
205 touch screen
210 person
215 finger
220 outline
225 thumbnail images
230 scrollbar
240 collage arrangement
245 individual images
305 film strip arrangement
310 preview window icon
315 previewed digital image
320 magnified digital image
325 directional user interface controls
400 option menu
410 tag person option
415 cancel option
500 current face
502 previously identified faces
505 directional user interface controls
510 refine search option
515 new search option
520 criteria menu
525 date option
530 people option
535 location option
540 keyword option

1. A method for searching a collection of digital images on a display screen, comprising:
entering an image review mode and displaying on the display screen a first digital image from the collection of digital images;
designating a face contained in the first digital image by using an interactive user interface to indicate a region of the displayed first digital image containing the face;
using a processor to execute an automatic face recognition algorithm to identify one or more additional digital images from the collection of digital images that contain the designated face; and
displaying the identified one or more additional digital images on the display screen.

2. The method of claim 1 wherein the one or more additional digital images are displayed as a set of thumbnail images.

3. The method of claim 2 wherein the thumbnail images are displayed within a scrollable window within the display screen.

4. The method of claim 1 wherein the one or more additional digital images are sequentially displayed on the display screen.

5. The method of claim 4 wherein the sequentially displayed images are displayed in a collage format.

6. The method of claim 1 wherein the display screen includes a touch screen user interface, and wherein the face contained in the first digital image is designated by interacting with the touch screen user interface according to a predefined user gesture.

7. The method of claim 6 wherein the predefined user gesture includes tapping on the face with a predefined number of taps, tracing a circle around the face, or tracing a diagonal line across the face.

8. The method of claim 1 wherein the face contained in the first digital image is designated using an interactive pointing device.

9. The method of claim 8 wherein the interactive pointing device is a mouse, a joystick, a track-ball, a track-pad, a remote control or a graphics tablet.

10. The method of claim 1 wherein the face recognition algorithm is used to provide face detection data including an indication of the location or size of identified faces.

11. The method of claim 1 wherein the face recognition algorithm is used to preprocess the collection of digital images to identify faces within the digital images and associate metadata with the digital images providing an indication of the identified faces, and wherein the one or more additional images are identified using the metadata.

12. The method of claim 1 further including:
providing a user interface to enable a user to define one or more additional search criteria; and
determining a subset of the identified one or more additional digital images that satisfy the one or more additional search criteria.
displaying the subset of the identified one or more additional digital images on the display screen.

13. The method of claim 12 wherein the one or more additional search criteria includes a date/time range search criterion, a geographic location search criterion, a keyword search criterion, an event search criteria or an additional face recognition search criterion.

14. The method of claim 1 wherein the display screen is located on a digital camera, and wherein the collection of digital images are images that have been captured by the digital camera.

15. The method of claim 1 wherein the display screen is a component of a digital picture frame, a handheld consumer electronic device, a cell phone.

16. The method of claim 1 wherein the display screen is a component of a computing system, and wherein the method is performed using a software application executed on the computing system.

17. The method of claim 1 wherein the method is performed using an internet software application.

18. A digital imaging device for browsing a collection of digital images, comprising:
a display screen;
a data processing system; and
a memory system communicatively connected to the data processing system, the memory system storing the collection of digital images and storing instructions configured to cause the data processing system to implement a method for searching the collection of digital images, wherein the instructions comprise:
entering an image review mode and displaying on the display screen a first digital image from the collection of digital images;
designating a face contained in the first digital image by using an interactive user interface to indicate a region of the displayed first digital image containing the face;
using a face recognition algorithm to identify one or more additional digital images from the collection of digital images that contain the designated face; and
displaying the identified one or more additional digital images on the display screen.

19. The digital imaging device of claim 18, wherein the digital imaging device is a digital camera, a digital picture frame, a digital imaging kiosk, a handheld consumer electronic device, a cell phone or a personal computer.
